(19) United States
(12) Patent Application Publication
(10) Pub. No.: US 2003/0039876 A1
(43) Pub. Date: Feb. 27, 2003

(54) Electrochemical fuel cell with fluid distribution layer having non-uniform perforations

(76) Inventors: Shanna Denine Knights, Burnaby (CA); David Pentreath Wilkinson, North Vancouver (CA); Paul Beattie, Port Moody (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/941,156

(22) Filed: Aug. 27, 2001

(51) Int. Cl. H01M 8/10; H01M 8/02

(52) U.S. Cl. 429/30; 429/34

(57) ABSTRACT

An electrochemical fuel cell comprises at least one fluid distribution layer comprising a substantially fluid impermeable sheet material which is rendered fluid permeable at least in the active area through the non-uniform application of perforations. In some embodiments, the size of the perforations in the fluid distribution layer increases in the reactant flow direction. In other embodiments, the density of the perforations in the fluid distribution layer increases in the reactant flow direction. The fluid permeability of the fluid distribution layer may also increase from the inlet to a mid-point between the inlet and the outlet and then decrease thereafter to the outlet.

### BACKGROUND OF THE INVENTION

1. Field of the Invention

This invention relates generally to electrochemical fuel cells. More specifically, the present invention relates to an electrochemical fuel cell which has at least one fluid distribution layer comprising a substantially fluid impermeable sheet material which is perforated non-uniformly.

2. Description of the Related Art

Electrochemical fuel cells convert reactants, namely, fuel and oxidant fluid streams, to generate electric power and reaction products. Solid polymer fuel cells typically employ a membrane electrode assembly (“MEA”) consisting of a solid polymer electrolyte or ion exchange membrane disposed between two electrode layers, namely a cathode and an anode. The membrane, in addition to being an ion conductive (typically proton conductive) material, also acts as a barrier for isolating the reactant streams from each other.

At the anode, the fuel stream moves through the porous anode substrate and is oxidized at the anode electrocatalyst layer. At the cathode, the oxidant stream moves through the porous cathode substrate and is reduced at the cathode electrocatalyst layer to form a reaction product. The location of the electrocatalyst generally defines the electrochemically active layer.

In electrochemical fuel cells, the MEA is typically interposed between two substantially fluid impermeable separator plates (anode and cathode plates). The plates typically act as current collectors and provide support to the MEA. The plates may have reactant channels formed therein and act as flow field plates providing access of the fuel and oxidant to the porous anode and cathode substrates, respectively, and providing for the removal of product water formed during operation of the cells.

The conditions in an operating fuel cell vary significantly across the electrochemically active area of each electrode. For example, as the oxidant is consumed, water is produced, the total gas pressure normally decreases and the oxidant partial pressure decreases. This results in a greater current density in the first third to half of the cell as compared to the latter half of the cell. Performance of the cell is likely limited by the high current density region, thereby resulting in an overall voltage lower than what would be obtained if the current density were uniformly distributed across the cell. High current density may also result in increased local temperatures that tend to lead to greater material degradation. Higher temperatures may also result in a decrease in the humidity at the inlet which can increase the likelihood of transfer leaks developing across the membrane and cause a loss of performance. This latter effect can be exacerbated if there is little or no humidification of the inlet reactant streams. While the inlet portion of the cell is likely to be too dry, the outlet portion of the cell is likely to have too much water which can result in localized flooding, uneven performance and increased mass transport losses. Thus, the requirements and desired properties of the fuel cell electrode will vary across the fuel cell.

U.S. Pat. No. 5,840,438 which is incorporated herein by reference, discloses the fuel cell performance benefits of imparting different fluid transport properties in a fuel cell electrode substrate, in a biased manner, between a reactant inlet and outlet. U.S. Pat. Nos. 4,808,493 and 5,702,839 disclose varying the loading or composition of the electrocatalyst or other components, in a fuel cell electrode layer in a biased manner between a reactant inlet and outlet.

PCT Publication No. WO 00/31813 discloses an additional perforated plate interposed between a separator plate and an adjacent porous fluid distribution layer wherein the perforations in the plate vary in size. Japanese Publication No. 2001-043868 discloses increasing the cross-sectional area of the flow field path in the separator plates between the reactant inlet and outlet. Conversely, Japanese Publication No. 2001-006717 discloses decreasing the cross-sectional area of the flow field path in the separator plates between the reactant inlet and outlet.

### BRIEF SUMMARY OF THE INVENTION

An electrochemical fuel cell comprises a fluid distribution layer comprising a substantially fluid impermeable material which is perforated in a non-uniform manner. The perforations extend from one of the major surfaces to the other allowing through-plane passage of reactants. In certain embodiments, a fuel cell comprises:

(a) a pair of substantially fluid impermeable separator plates;

(b) a pair of fluid distribution layers interposed between the separator plates, each of the fluid distribution layers having two major planar surfaces, at least one of the fluid distribution layers comprising a substantially fluid impermeable sheet material comprising a plurality of perforations to render the layer fluid permeable in the through-plane direction at least in an electrochemically active region;

(c) a plurality of reactant flow passages for directing a reactant stream across the major planar surfaces facing the adjacent separator plate from an inlet to an outlet wherein the flow passages comprise reactant flow channels on either a surface of the separator plate or a surface of the fluid distribution layer;

(d) an ion exchange membrane interposed between at least a portion of the fluid distribution layers; and

(e) electrocatalyst interposed between at least a portion of each of the fluid distribution layers and at least a portion of the membrane, thereby defining the active region.

At least one of the fluid distribution layers is perforated in a non-uniform manner to impart a different fluid permeability in the through-plane direction in different regions of the fluid distribution layer.

In one embodiment, the perforations in the fluid distribution layer increase in size, for example, in a graded or banded manner in the general direction of the flow of reactant from the inlet to the outlet of the cell.

In another embodiment, the perforations in the fluid distribution layer increase in density, for example, in either a graded or banded manner in the general direction of the flow of reactant from the inlet to the outlet of the cell.

In still another embodiment, the fluid permeability in the through-plane direction of the fluid distribution layer increases in the general direction of flow of reactant from the inlet to a mid-point between the inlet and the outlet and then decreases from the mid-point to the outlet.

Gaskets or seals may be provided between the separator plates and fluid distribution layers and/or between the membrane and fluid distribution layers, for example, as described in U.S. Pat. Nos. 5,464,700; 5,176,966; and 5,284,718 which are hereby incorporated by reference.

### BRIEF DESCRIPTION OF THE SEVERAL VIEWS OF THE DRAWINGS

FIG. 1 is an exploded sectional view of a conventional electrochemical fuel cell showing an MEA interposed between two flow field plates.

FIG. 2 is an exploded sectional view of an electrochemical fuel cell which includes a pair of fluid flow field plates and a pair of fluid distribution layers wherein the fluid distribution layers include a substantially fluid impermeable sheet material having a plurality of perforations formed in the electrochemically active region thereof.

FIG. 3 is an exploded sectional view of an electrochemical fuel cell which includes a pair of separator plates and a pair of fluid distribution layers wherein the fluid distribution layers include: a substantially fluid impermeable sheet material having a plurality of perforations in the electrochemically active region thereof; and fluid flow channels formed in a major surface thereof.

FIG. 4A is a plan view of a perforated fluid distribution layer wherein the perforations increase in size in a graded manner along the reactant flow field path from the inlet to the outlet.

FIG. 4B is a plan view of a perforated fluid distribution layer wherein the perforations increase in size in a banded manner along the flow field path from the inlet to the outlet.

FIG. 5A is a plan view of a perforated fluid distribution layer wherein the density of the perforations increases along the flow field path from the inlet to the outlet.

FIG. 5B is a plan view of a perforated fluid distribution layer wherein the density of the perforations increases along the flow field path from the inlet to the outlet.

FIG. 6A is a sectional view of a perforated fluid distribution layer illustrating different configurations of the perforations as traversed in the through-plane.

FIG. 6B is a plan view of a fluid distribution layer further illustrating additional features radiating from the perforations on one planar surface of the fluid distribution layer.

### DETAILED DESCRIPTION OF THE INVENTION

The fluid distribution layers are electrically conductive and fluid permeable, at least in the region corresponding to the electrochemically active region of the fuel cell. Electrical conductivity allows for the electron flow from the anode to the cathode through an external load. Permeability allows for the supply of fuel and oxidant from the fuel and oxidant streams respectively to the electrocatalyst where the electrochemical reaction occurs. Conventional fluid distribution layers typically comprise porous, electrically conductive and fluid permeable preformed sheets composed of materials such as, for example, carbon fiber paper, woven or non-woven carbon fabric, metal mesh or gauze, or microporous polymeric film.

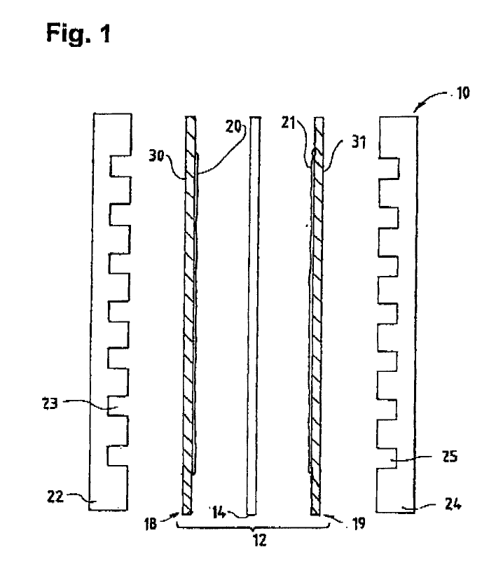

FIG. 1 illustrates a conventional fuel cell 10. Fuel cell 10 includes a membrane electrode assembly 12 interposed between anode flow field plate 22 and cathode flow field plate 24. Membrane electrode assembly 12 consists of an ion exchange membrane 14 interposed between two electrodes, namely, anode 18 and cathode 19. In conventional fuel cells, anode 18 and cathode 19 comprise a fluid distribution layer of porous electrically conductive sheet material 30 and 31, respectively. Each fluid distribution layer has a thin layer of electrocatalyst 20 and 21, such as platinum black or a carbon-supported platinum catalyst, disposed on one of the major surfaces at the interface with membrane 14 to render each electrode electrochemically active. Membrane electrode assembly 12 is interposed between anode flow field plate 22 and cathode flow field plate 24. Anode flow field plate 22 has at least one fuel channel 23 formed in its surface facing anode fluid distribution layer 30. Cathode flow field plate 24 has at least one oxidant flow channel 25 formed in its surface facing cathode fluid distribution layer 31. When assembled against the cooperating surfaces of fluid distribution layers 30 and 31, channels 23 and 25 form reactant flow field passages for the fuel and oxidant, respectively.

Instead of a porous electrically conductive fluid distribution layer, the fluid distribution layer may be composed of a substantially fluid impermeable material as in the present approach wherein the sheet material is rendered fluid permeable at least in the active region by, for example, perforating the sheet material. Perforating the sheet material, at least in the active region, permits the passage of reactant fluid between the two major planar surfaces thereof and to the electrocatalyst layer. U.S. Pat. No. 5,976,726, which is hereby incorporated by reference, discloses the use of such a substantially fluid impermeable sheet material.

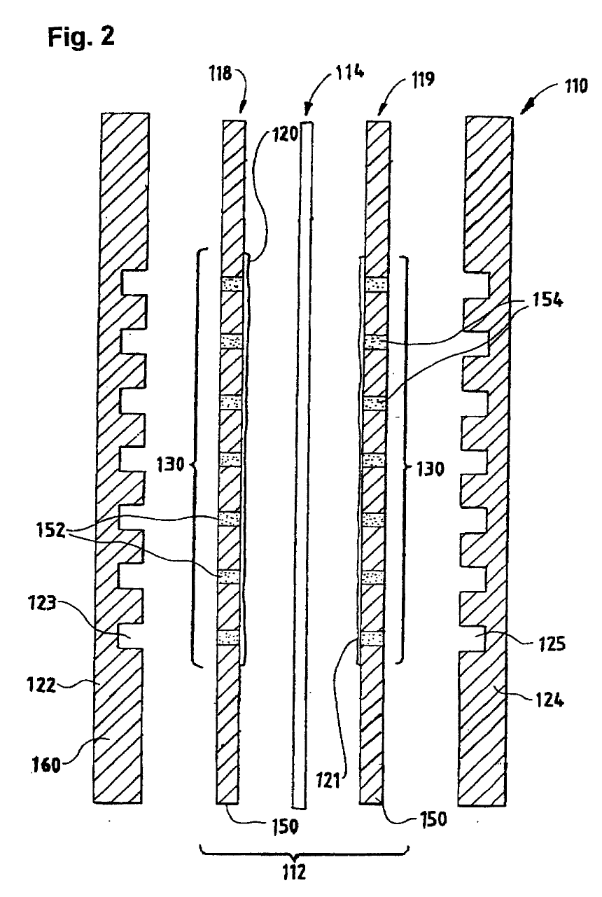

FIG. 2 is an exploded sectional view of a fuel cell 110 comprising such a fluid distribution layer comprising a perforated substantially fluid impermeable material. Fuel cell 110 includes a membrane electrode assembly 112, including an ion exchange membrane 114 interposed between an anode fluid distribution layer and a cathode fluid distribution layer 118 and 119 respectively, with a quantity of electrocatalyst disposed in a layer 120, 121 at the interface between each fluid distribution layer 118 and 119 and membrane 114 in the electrochemically active region 130 of the fluid distribution layers 118 and 119. The membrane electrode assembly 112 is interposed between an anode flow field plate 122 and a cathode flow field plate 124, each plate having an open-faced channel 123, 125 formed in its surface facing the corresponding fluid distribution layer 118, 119. The fluid distribution layers 118, 119 comprise a substantially fluid impermeable sheet material 150 that is perforated at least in the electrochemically active region. Perforations 152 render the respective fluid distribution layer fluid permeable at least in the through-plane direction. The perforations 152 may contain a filler material 154 which is preferably electrically conductive. However, if substantially fluid impermeable sheet material 150 is electrically conductive, filler material 154 may be electrically insulating. For example, filler material 154 may comprise particulate carbon or hydrophilic or hydrophobic materials, which do not completely block the perforations to passage of reactant. The membrane electrode assembly 112 optionally contains gaskets (not shown) to form a seal circumscribing the electrochemically active region of each fluid distribution layer 118, 119.

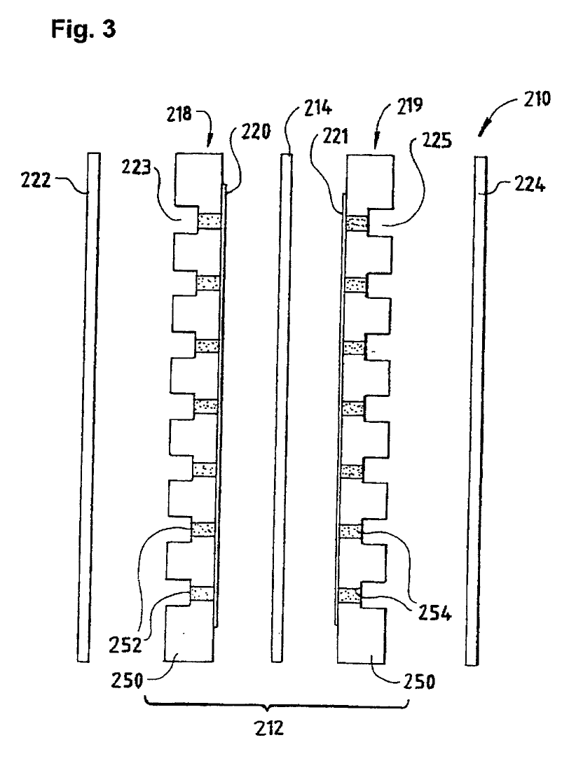

FIG. 3 is an exploded sectional view of a fuel cell 210 comprising a fluid distribution layer comprising a perforated substantially fluid impermeable material and further comprising integrated fluid flow channels. Fuel cell 210 includes a membrane electrode assembly 212, including an ion exchange membrane 214 interposed between an anode fluid distribution layer and a cathode fluid distribution layer 218 and 219 respectively, with a quantity of electrocatalyst disposed in a layer 220, 221 at the interface between each fluid distribution layer 218 and 219 and membrane 214. The membrane electrode assembly 212 is interposed between an anode separator plate 222 and a cathode separator plate 224. Each fluid distribution layer comprises open-faced channels 223, 225 formed in its surface facing the corresponding separator plate 222, 224. The fluid distribution layers 218, 219 comprise a perforated substantially fluid impermeable sheet material 250. Perforations 252 render the respective fluid distribution layer fluid permeable at least in the through-plane direction. Perforations 252 may contain a filler material 254 which is preferably electrically conductive. However, if substantially fluid impermeable sheet material 150 is electrically conductive, filler material 154 may be electrically insulating. The membrane electrode assembly 212 optionally contains gaskets (not shown) to form a seal circumscribing the electrochemically active region of each fluid distribution layer 218, 219.

The substantially fluid impermeable sheet material 150 in FIG. 2 and 250 in FIG. 3 is preferably formed from an electrically conductive material such as flexible graphite, carbon resin or a metal and may further comprise a filler material within perforations in the active region. Preferably, flexible graphite, also known as graphite foil, exfoliated graphite and expanded graphite, is used.

In the present fuel cell, the fluid distribution layer comprises a substantially fluid impermeable sheet material as illustrated in either FIG. 2 or 3 wherein the perforations are non-uniform across the fluid distribution layer. The electrochemical reaction rate and fluid transport properties can be controlled by varying the perforation distribution, number, size, shape or any combination thereof across the active region. The fuel cell can thus be designed for improved current density distribution and appropriate humidity across the membrane.

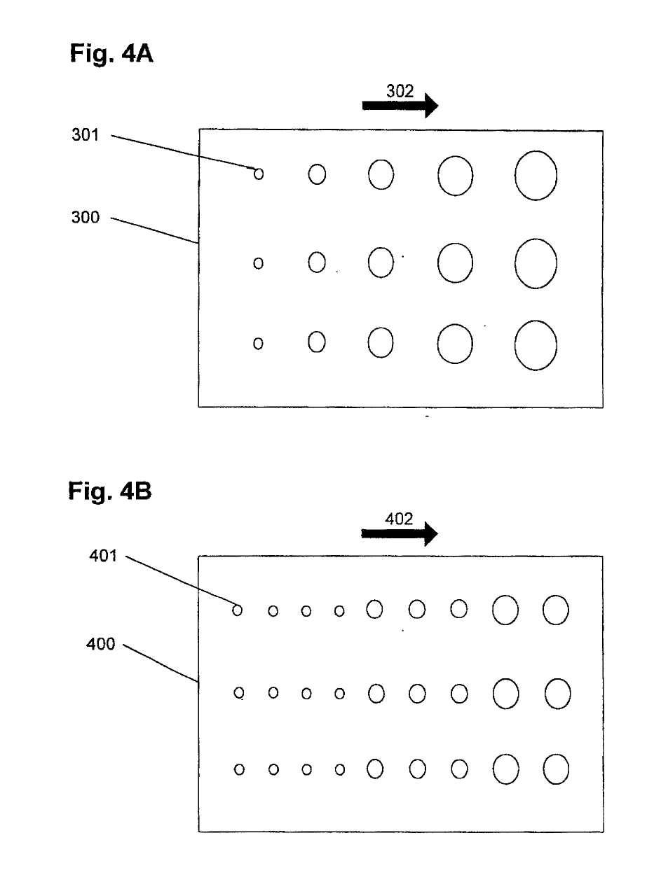

FIG. 4A illustrates one embodiment of the present fluid distribution layer 300 wherein the perforations 301 increase in size in a graded manner as the layer is traversed in-plane along the reactant flow path from the inlet to the outlet. The arrow 302 shows the general direction of reactant flow.

FIG. 4B illustrates another embodiment of the present fluid distribution layer 400 wherein the perforations 401 increase in size in a banded manner as the layer is traversed in-plane along the reactant flow path from the inlet to the outlet. The arrow 402 shows the general direction of reactant flow.

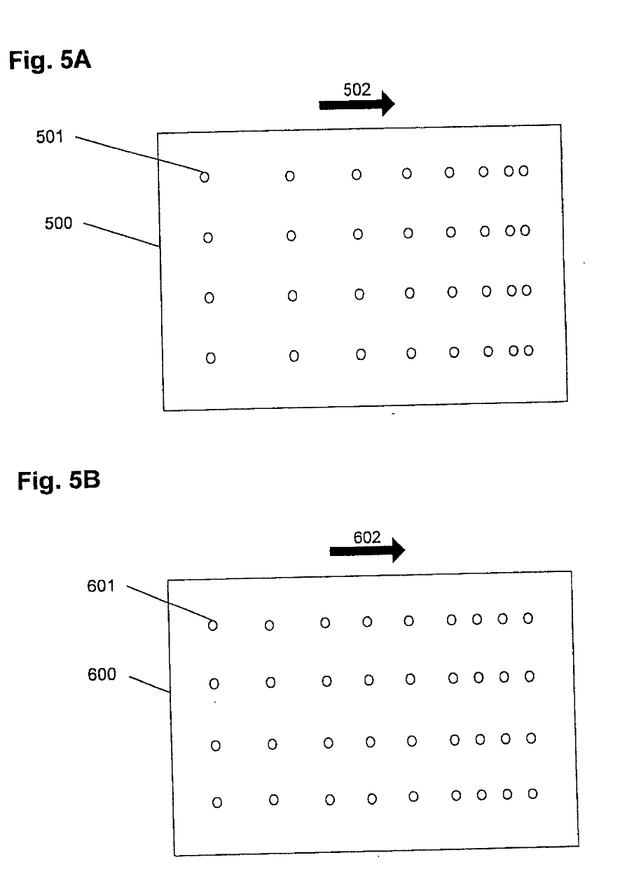

FIG. 5A illustrates a third embodiment of the present fluid distribution layer 500 wherein the density of the perforations 501 increases in a graded manner along the reactant flow path from the inlet to the outlet. The arrow 502 shows the general direction of reactant flow.

FIG. 5B illustrates a fourth embodiment of the present fluid distribution layer 600 wherein the density of the perforations 601 increases in a banded manner along the reactant flow path from the inlet to the outlet. The arrow 602 shows the general direction of reactant flow.

If the reactant flow path is substantially linear between the inlet and the outlet, then the patterns of the perforations used for the fluid distribution layers may resemble those shown for the embodiments illustrated in FIG. 4A, 4B, 5A or 5B. However, if the reactant flow path follows, for example, a serpentine path from the inlet to the outlet, it may be desirable to vary the perforations along a similar serpentine path on the fluid distribution layer.

In a further embodiment of the present fuel cell not illustrated, both the size and density of the perforations increase along the reactant flow path from the inlet to the outlet in either a graded or banded manner.

The present fuel cell allows better control of operating conditions and current density across the cell. Further, the inlet may be protected from the drying effect of the inlet reactant stream due to reduced contact with the incoming stream. Conversely, there may be greater contact with the reactant stream and therefore greater water transport in the outlet portion of the cell where accumulating water may otherwise cause localized flooding and restrict access of the reactant to the catalyst. This results in a fuel cell with greater reliability and durability. Better thermal management may also be present due to the increased landing area in the inlet region. An additional significant advantage of the present fuel cell is that reactant access to the catalyst, and water transport, are engineered properties that do not rely on bulk or average properties of the fluid distribution layer. This facilitates progress towards optimizing the localized cell operating conditions.

It may be advantageous in some circumstances to decrease the through-plane fluid permeability of the fluid distribution layer along a portion of the reactant flow path. For example, when the anode and cathode are in counterflow arrangement, the dry inlet region of a first electrode is aligned through the intervening, water permeable membrane electrolyte with the outlet region of a second electrode. Water may migrate from the wetter outlet region of the second electrode across the membrane to the dry inlet region of the first electrode. In this case, it can be advantageous if the fluid distribution layer has a decreasing fluid permeability in the outlet region. This approach may be combined with previous embodiments whereby the through-plane fluid permeability of the fluid distribution layer increases from the inlet to a mid-point along the flow path and then decreases from the mid-point to the outlet.

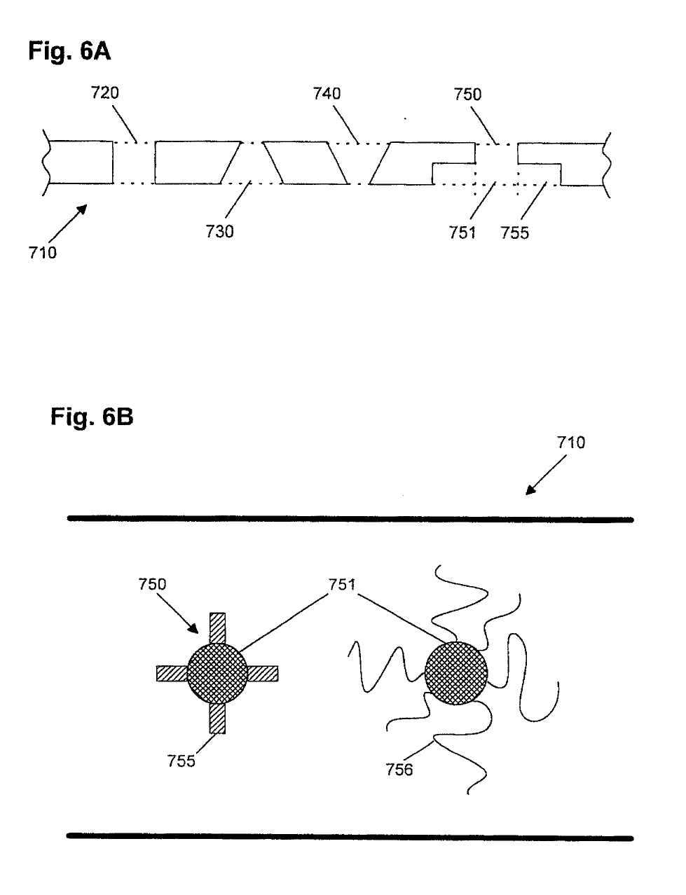

FIG. 6A is a sectional view of a fluid distribution layer 710. As the perforations are traversed in the through-plane direction, the perforations can be substantially uniform in cross-section as shown as perforation 720. Alternatively the perforation may increase in size as shown in perforation 730 or decrease in size as shown in perforation 740. There may also be additional grooves on one planar surface of fluid distribution layer 710 as shown as perforation 750 comprising a central passage 751 that traverses the fluid distribution layer in the through-plane direction and a radiating groove 755. FIG. 6B is a plan view of a portion of fluid distribution layer 710 further illustrating pore 750 comprising a central passage 751 and grooves 755 or 756 radiating outward therefrom. Such grooves, if on the planar side facing the membrane can provide better access of reactant to electrocatalyst.

While the embodiments as illustrated in FIGS. 4A, 4B, 5A and 5B show the perforations as being substantially cylindrical, it is understood that other shapes may be used and that the shape can be varied along the flow path in addition to the size and/or density of the perforations. This may include, for example, varying the perforations in the through-plane direction along the flow path.

The non-uniform fluid distribution layer can be the anode fluid distribution layer, the cathode fluid distribution layer or both. Further, if both the anode and the cathode fluid distribution layers are non-uniformly perforated, the pattern resulting from such perforations can be the same or different as between the anode and the cathode.

In any of the foregoing embodiments, the fluid distribution layer may be interposed between a separator plate and a membrane which has been coated with an electrocatalyst-containing layer and optionally other electrically conductive, fluid permeable layers.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications as incorporate those features which come within the spirit and scope of the invention.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An electrochemical fuel cell comprising:
(a) a pair of substantially fluid impermeable separator plates;
(b) a pair of fluid distribution layers interposed between the separator plates, each of the fluid distribution layers having two major planar surfaces, at least one of the fluid distribution layers comprising a substantially fluid impermeable sheet material comprising a plurality of perforations to render the at least one fluid distribution layer fluid permeable in the through-plane direction at least in an electrochemically active region;
(c) a plurality of reactant flow passages for directing a reactant stream across the major planar surfaces facing the adjacent separator plate from an inlet to an outlet;
(d) an ion exchange membrane interposed between at least a portion of the fluid distribution layers; and
(e) electrocatalyst interposed between at least a portion of each of the fluid distribution layers and at least a portion of the membrane, thereby defining the active region.
wherein the plurality of perforations impart a different fluid permeability in the through-plane direction in different regions of the at least one fluid distribution layer.

2. The electrochemical fuel cell of claim 1 wherein the passages comprise reactant flow channels on a surface of the separator plate facing the adjacent fluid distribution layer.

3. The electrochemical fuel cell of claim 2 wherein the separator plates are directly adjacent to the fluid distribution layers.

4. The electrochemical fuel cell of claim 3 wherein the substantially fluid impermeable sheet material is flexible graphite.

5. The electrochemical fuel cell of claim 3 wherein the fluid distribution layer is increasingly fluid permeable in the through-plane direction as the layer is traversed from the inlet to the outlet.

6. The electrochemical fuel cell of claim 5 wherein the perforations in the at least one substantially fluid impermeable sheet material are smaller in a region near the inlet as compared to a similar region near the outlet.

7. The electrochemical fuel cell of claim 6 wherein the perforations increase in size in a graded manner from the inlet to the outlet.

8. The electrochemical fuel cell of claim 6 wherein the perforations increase in size in a banded manner from the inlet to the outlet.

9. The electrochemical fuel cell of claim 5 wherein the perforations in the at least one substantially fluid impermeable sheet material are more closely spaced in a region near the outlet as compared to a similar region near the inlet.

10. The electrochemical fuel cell of claim 9 wherein the density of the perforations increases in a graded manner from the inlet to the outlet.

11. The electrochemical fuel cell of claim 9 wherein the density of the perforations increases in a banded manner from the inlet to the outlet.

12. The electrochemical fuel cell of claim 3 wherein the fluid distribution layer is decreasingly fluid permeable in the through-plane direction as the layer is traversed from a mid-point between the inlet and the outlet to the outlet.

13. The electrochemical fuel cell of claim 12 wherein the fluid distribution layer is increasingly fluid permeable in the through-plane direction as the layer is traversed from the inlet to the mid-point.

14. The electrochemical fuel cell of claim 1 wherein the passages comprise reactant flow channels on the planar surface of the fluid distribution layer facing the adjacent separator plate.

15. The electrochemical fuel cell of claim 14 wherein the fluid distribution layers are directly adjacent to the separator plates.

16. The electrochemical fuel cell of claim 15 wherein the substantially fluid impermeable sheet material is flexible graphite.

17. The electrochemical fuel cell of claim 15 wherein the fluid distribution layer is increasingly fluid permeable in the through-plane direction as the layer is traversed from the inlet to the outlet.

18. The electrochemical fuel cell of claim 17 wherein the perforations in the at least one substantially fluid impermeable sheet material are smaller in a region near the inlet as compared to a similar region near the outlet.

19. The electrochemical fuel cell of claim 18 wherein the perforations increase in size in a graded manner from the inlet to the outlet.

20. The electrochemical fuel cell of claim 18 wherein the perforations increase in size in a banded manner from the inlet to the outlet.

21. The electrochemical fuel cell of claim 17 wherein the perforations in the at least one substantially fluid impermeable sheet material are more closely spaced in a region near the outlet as compared to a similar region near the inlet.

22. The electrochemical fuel cell of claim 21 wherein the density of the perforations increases in a graded manner from the inlet to the outlet.

23. The electrochemical fuel cell of claim 21 wherein the density of the perforations increases in a banded manner from the inlet to the outlet.

24. The electrochemical fuel cell of claim 15 wherein the fluid distribution layer is decreasingly fluid permeable in the through-plane direction as the layer is traversed from a mid-point between the inlet and the outlet to the outlet.

25. The electrochemical fuel cell of claim 24 wherein the fluid distribution layer is increasingly fluid permeable in the through-plane direction as the layer is traversed form the inlet to the mid-point.
